(19) United States
(12) Patent Application Publication
(10) Pub. No.: US 2016/0315559 A1
(43) Pub. Date: Oct. 27, 2016

(54) CONNECTION APPARATUS

(71) Applicant: SQUAREX INC., New Taipei (TW)

(72) Inventors: Jung-Ya Hsieh, New Taipei (TW); Ta-Wei Chien, New Taipei (TW); Yao-Tsung Yeh, New Taipei (TW); Shu-Ming Wei, New Taipei (TW); Cheng-Yu Tsai, New Taipei (TW); Kuo-Wei Lu, New Taipei (TW); Kuei-Yuan Chen, New Taipei (TW)

(21) Appl. No.: 14/996,396

(22) Filed: Jan. 15, 2016

Related U.S. Application Data
(63) Continuation of application No. 62/151,369, filed on Apr. 22, 2015.

(30) Foreign Application Priority Data
Jan. 6, 2016 (TW) 105100252

(51) Int. Cl. H02M 11/00

(52) U.S. Cl. CPC H02M 11/00

(57) ABSTRACT

A connection apparatus which includes a case and an adapter, the case has an connecting device, the connecting device has at least one electrical terminal, and each electrical terminal is at different positions of the case, the locating devices are configured to fix the case on a fixture, the adapter is installed inside of the case, the adapter has a circuit control device and at least one power transmission device, the circuit control device is electrically connected with the connecting device and the power transmission devices.

### FIELD

The subject matter herein generally relates to a connection apparatus, particularly referring to a connection apparatus that is capable of being adapted to different situations, providing optional voltage power source, and conveniently creating display efficiency.

### BACKGROUND

In the field of connection technologies, connections currently used provide connections between a fixed object and a hanging object, and generally these sort of connections have no power supply to it. Power distribution devices need to be installed when power is needed. Hence, extra space between the fixed object and the hanging object is necessary. But, due to the lack of integral connective configuration between the present connections and the power distribution device, coordinative integration of the connections and the power distribution device is required when the hanged object design is displayed with the combination surface of the same power or with the combination of different voltage power sources and thus, creates complexities and difficulties when integrating. Moreover, changing the design of display is the solution when hard to integrate the connections and the power distribution device, which creates an obvious inconvenience to special display design.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Implementations of the present technology will now be described, by way of example only, with reference to the attached figure.

FIG. 1 is a schematic view of an embodiment of the connection apparatus of the present disclosure.

FIG. 2 is a block schematic view illustrating the adapter of the connection apparatus of the present disclosure.

FIG. 3 is a schematic view of another embodiment of the connection apparatus of the present disclosure.

FIG. 4 is a schematic view illustrating the use of a hanger of the connection apparatus in FIG. 3.

FIG. 5 is a schematic view of another embodiment illustrating the hanger of the connection apparatus in FIG. 4.

FIG. 6 is a rear view illustrating a hanging object of the connection apparatus in FIG. 1.

### DETAILED DESCRIPTION OF EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

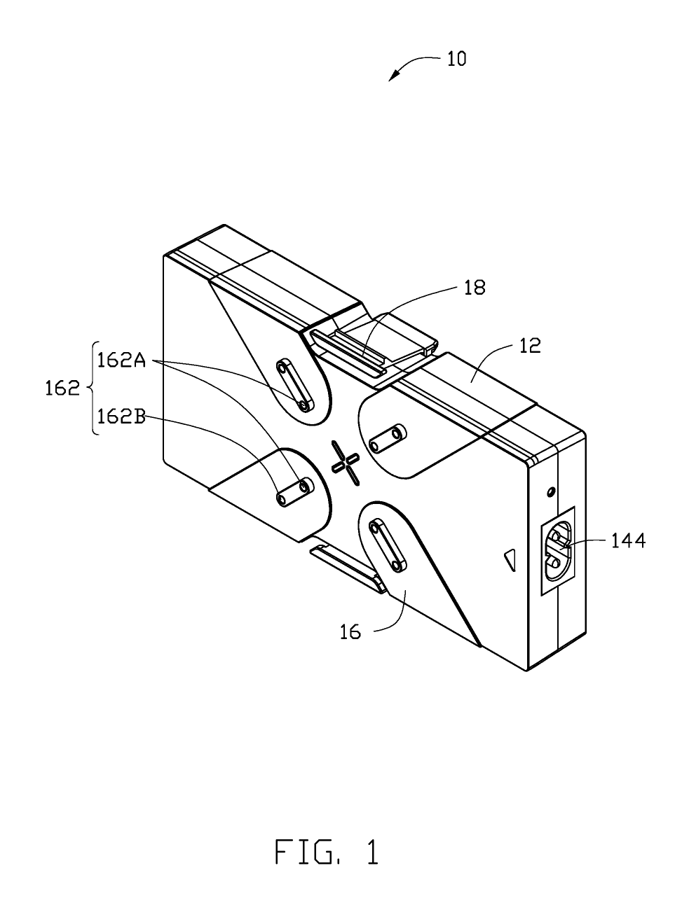

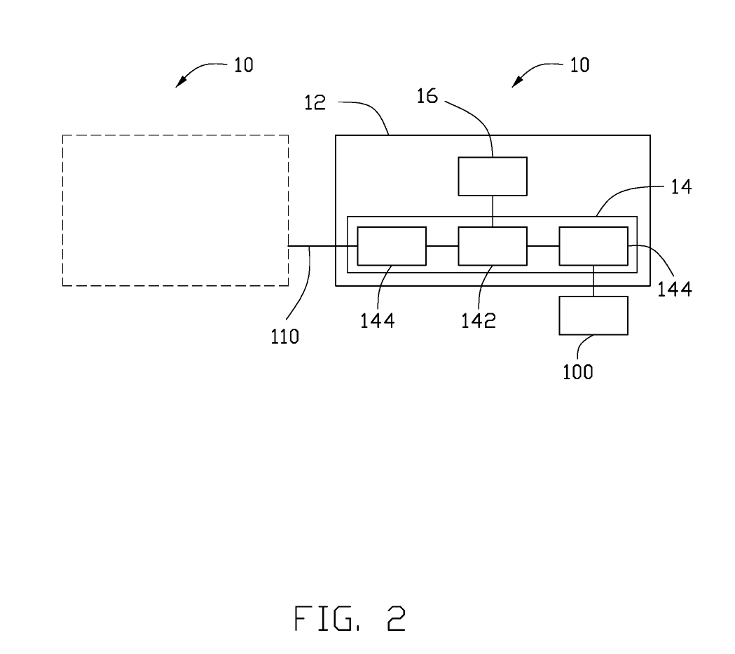

FIG. 1 illustrates a schematic view of an embodiment of the connection apparatus of the present disclosure. The connection apparatus 10 comprises a case 12 and an adapter 14 (as shown in FIG. 2), the case 12 includes a connecting device 16, and the connecting device 16 has at least one electrical terminal 162. In the present embodiment, two electrical terminals 162 are installed in cross-shape on a base of the connecting device 16. The two electrical terminals have been labeled as 162A and 162B. The two electrical terminals 162A and 162B are respectively and correspondingly aligned at different positions on the case 12 in a larger cross-shape and a smaller cross-shape. The electrical terminals 162 are configured to be aligned correspondingly in big and small configurations and at different positions. The configuration of corresponding alignments includes a cross-shape, circle, rectangle, polygon, etc. Notably, if the electrical terminals 162 are configured to be positive and negative electrode terminals, the positive and negative electrode terminals are configured to be aligned correspondingly at different locations. For example, the positive terminal is circle shaped, the negative terminal would be circle shaped surrounding the outside of the positive terminal, and configured to be aligned correspondingly at efficient locations. The case 12 has at least one locating device 18, installed inside the case 12 via a fixed hole (not shown), the fixed hole is configured to fasten the case 12 onto the fixed object via a screw (not shown). The locating device 18 is installed at the outside of the case 12 and is an elastic buckle and connected via the fixed hole of the fixed object, fastening the case 12 onto the fixed object. In other embodiments the locating device 18 installed on the outside of the case 12 can be an adhesive, for example, gel, tape, Velcro, etc. The adhesive is installed on the rear side of the connecting device 16, which allows the case 12 to be easily adhered to the fixed object. The fixed object can be a wall surface, a pedestal frame, a vertical frame, a hanger etc.

FIG. 2 is a block schematic view illustrating an adapter 14 of the connection apparatus of the present disclosure. The adapter 14 is installed inside the case 12, the adapter 14 has a circuit control device 142 and at least one power transmission device 144, wherein the circuit control device 142 connects respectively with the connective device 16 and the power transmission devices 144. The power transmission devices 144 includes an input port and an output port. The input port electrically couples with a power source 100. The output port connects, when there is some distance between two of the power transmission devices 144 of the connection apparatus 10 which connects through a cable 110, with the corresponding power transmission devices 144 of the connection apparatus 10. The adapter 14 connects with the power source 100 through the power transmission device 144. The circuit control device 142 can change the voltage of the power source 100. In the meantime, the circuit control device 142 connects the different voltages of the power source 100 with the electrical terminals 162 located at the different positions of the case 12. Different voltage sources 100 provided by the electrical terminals 162 at different positions can easily be connected to hanging objects (not shown in the figure) needing different voltage sources 100.

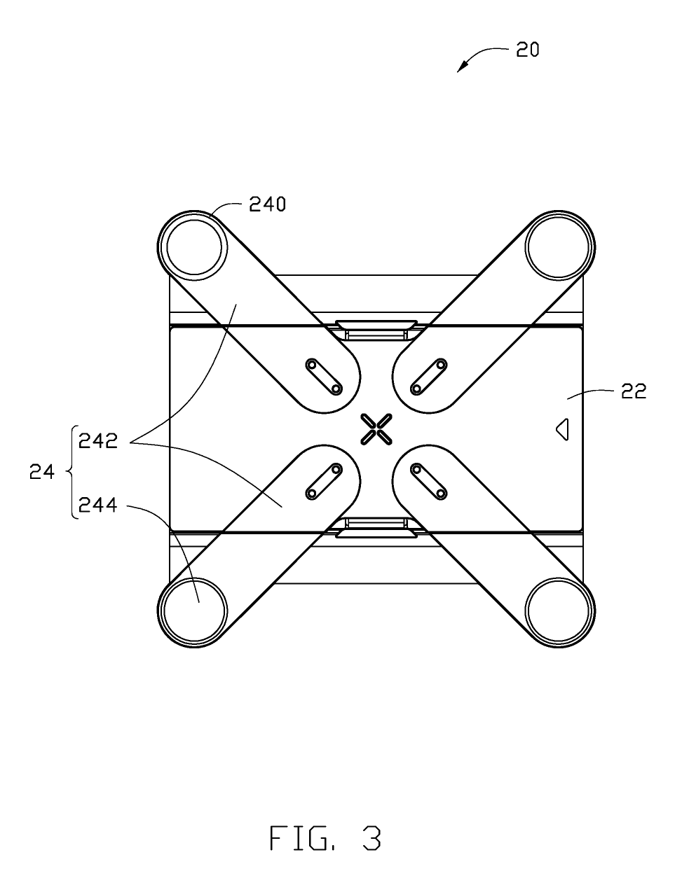

FIG. 3 is a schematic view of another embodiment of the connection apparatus of the present disclosure. The connection apparatus 20 is essentially the same as the connection apparatus 10. However, the difference is that the connection apparatus 20 comprises a case 22, an adapter (not shown), and at least one supporting frame 24. The at least one supporting frame 24 is installed on the case 22 and is integrally formed with the case 22. The at least one supporting frame comprises at least one supporting pillar 242, a supporting element 244 is formed on the one supporting pillar, for connecting with a hanging object (not shown). The example, the supporting element 244 is protruded from the supporting pillar 242 as a protrusion. However, the supporting element 244 should not be limited to a protrusion; any form of supporting element that is capable of supporting can be used in this embodiment, such as a button or a hook. Furthermore, a gap 240 is defined between the supporting element 244 and the supporting pillar 242; the hanging object is hung through the gap 240.

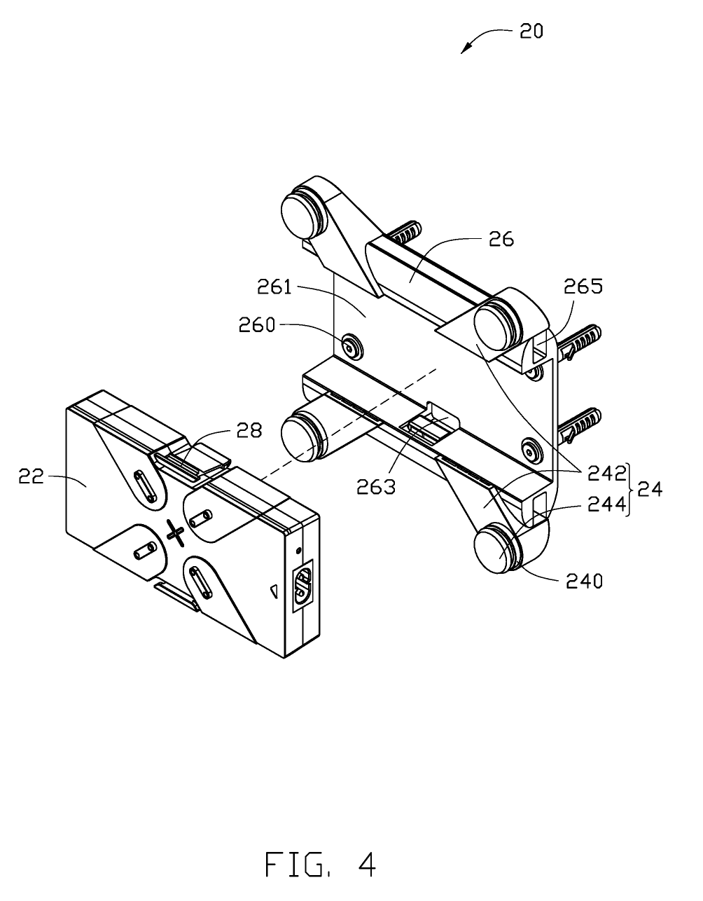

FIG. 4 is a schematic view illustrating the use of a hanger of the connection apparatus in FIG. 3. The supporting frame 24 is installed on the hanger 26, and the supporting frame 24 and hanger 26 are integrally formed. The hanger 26 defines a depression 261 including at least one fastening holes 263, and the hanger 26 is firmly secured with a screw 260 through the fastening holes 263. The connection apparatus 20 fixed on the hanger 26 is fastened with the fastening holes 263 through the locating device 28 on the case 22. Fastening elements 265 are respectively provided at the two ends of the depression 261; the two corresponding hangers 26 can be collectively combined, allowing the hangers 26 be extended, through the fastening elements 265.

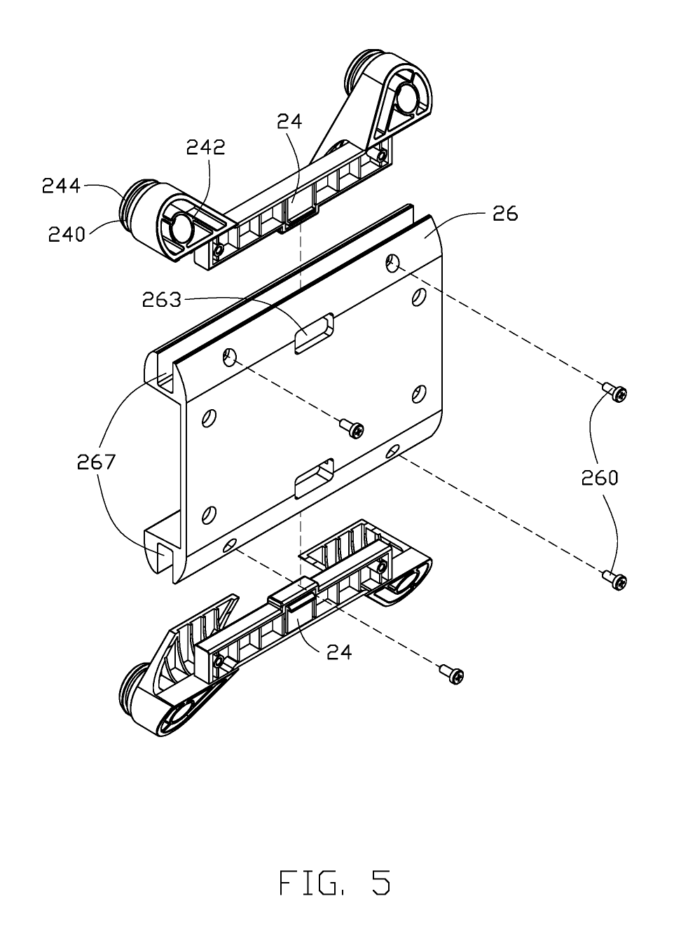

FIG. 5 is a schematic view of another embodiment illustrating the hanger of the connection apparatus in FIG. 4. The hanger 26 has at least one connective slot 267 for installing the supporting frame 24. In the present embodiment, the supporting frame 24 is installed in the connective slot 267 and fixed firmly by the screw 260. The hanger 26 can be connected with different supporting frames 24 and different hanging objects with the detachable structure of the supporting frame 24.

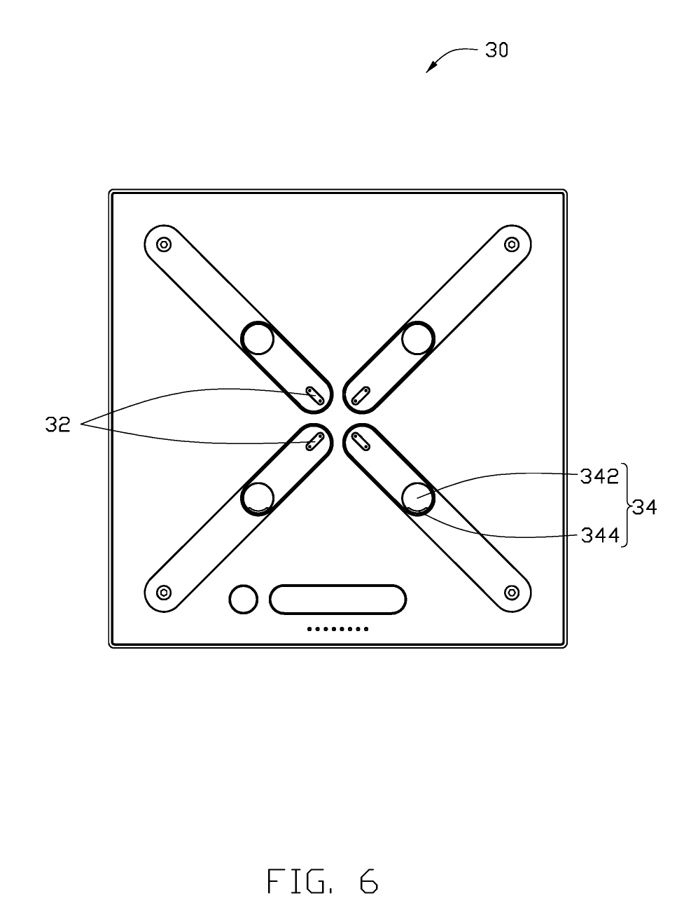

The hanging object 30 (as shown in FIG. 6), corresponding to the connection apparatus 10, 20 has an electrical receiving device 32 and a connective base 34 on the rear side of the hanging object. The electrical receiving device 32 electrically couples with connecting device 16 of the connection apparatus 10 and guides an appropriate voltage source 100 to the hanging object 30 to use through the contact of the pole of the electrical receiving device 32 and the electrical terminal 162. The connective base 34 is correspondingly combined with the supporting frame 24. In the present embodiment, the connective base 34 has a seat hole 342 corresponding to the supporting element 244 of the supporting frame 24; therefore, the protruding button of the supporting element 244 is allowed to protrude inside the seat hole 342. A fastening structure 344 is installed inside the seat hole 342; the fastening structure 344 is elastic and can be controlled by the control device (not shown in the figure) of the hanging object 30. When the protruding button of the supporting element 244 is stretched into the seat hole 342, the fastening structure 344 stretches automatically into the gap 240 between the protruding button of the supporting element 244 and the supporting pillar 242; therefore, the hanging object 30 is allowed to be fixed onto the supporting frame 24. The control device of the hanging object 30 controls the stretching of the fastening structure 344 inside the hole seat 342; the hanging object 30 can be dismantled from the supporting frame 24 when the control device of the hanging object 30 controls the fastening structure 344 to stretch into the hole seat 342. Therefore, the hanging object 30 can be mounted onto or dismounted from the connection apparatus 10, 20 fairly easy, and the connection apparatus 10, 20 provides the hanging object 30 appropriate space for power distribution.

According to the present disclosure, the hanging object 30 can be mounted or dismounted easily by the supporting frame 24; the electrical terminals 162 of the connecting device 16 of the case 12, 22 can be easily connected to the voltage sources 100 provided. The connection apparatus 10, 20 can be employed as a power distribution device, which sufficiently supports and cooperates to be a space design and informational expression.

The embodiments shown and described above are only examples. Many details are often found in the art such as the other features of a connection apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A connection apparatus, comprising:
a case including an connecting device that has at least one electrical terminal, which as installed at a positions of the case; and
an adapter being installed inside of the case and has a circuit control device and at least one power transmission device, wherein the circuit control device electrically connects with the connecting device and the at least one power transmission device.

2. The connection apparatus as claimed in claim 1, wherein the case has a supporting frame, the supporting frame comprises at least one supporting pillars, a supporting element is provided on the supporting pillars, and the supporting element connects with a hanged object.

3. The connection apparatus as claimed in claim 2, wherein the supporting element is a protruding button installing at the end point of the supporting pillar, a gap is provided between the protruding button and the supporting pillar.

4. The connection apparatus as claimed in claim 2, wherein the case has at least one connective slots installing the supporting frame.

5. The connection apparatus as claimed in claim 2, wherein hanged object has a conductive device, the conductive device electrically connects with the electrical terminals of the connecting device.

6. The connection apparatus as claimed in claim 1, wherein the case has at least one locating devices connecting with a hanging apparatus.

7. The connection apparatus as claimed in claim 6, wherein the locating devices is an elastic buckle.

8. The connection apparatus as claimed in claim 6, wherein the hanging apparatus has a slot, at least one fixed holes are provided in the slot, the fixed holes and the elastic buckle are collectively buckled.

9. The connection apparatus as claimed in claim 1, wherein the electrical terminals are located at the different positions of the case, and are configured in corresponding line shape.

10. The connection apparatus as claimed in claim 9, wherein the configuration of the corresponding lining comprises cross-shape, circle, rectangle, polygon.

11. The connection apparatus as claimed in claim 1, wherein the power transmission device includes an input port and an output port, the input port connects with a power source, and the output port connects with the corresponding connection apparatus.

12. A connection apparatus, comprising:
a case including an connecting device that has at least one electrical terminal, which as installed at a positions of the case;
an adapter being installed inside of the case and has a circuit control device and at least one power transmission device, wherein the circuit control device electrically connects with the connecting device and the at least one power transmission device; and
at least one supporting frames;
wherein, the supporting frame comprises at least one supporting pillars, a supporting element is provided on the supporting pillar, and the supporting element connects to a hanged object.

13. The connection apparatus as claimed in claim 12, wherein the supporting element is a protruding button installing at the end point of the supporting pillar, a gap is provided between the protruding button and the supporting pillar.

14. The connection apparatus as claimed in claim 12, wherein the case has at least one connective slots installing the supporting frame.

15. The connection apparatus as claimed in claim 12, wherein hanged object has a conductive device, the conductive device electrically connects with the electrical terminals of the connecting device.

16. The connection apparatus as claimed in claim 12, wherein the electrical terminals are located at the different positions of the case, and are configured in corresponding line shape.

17. The connection apparatus as claimed in claim 12, wherein the configuration of the corresponding lining comprises cross-shape, circle, rectangle, polygon.

18. The connection apparatus as claimed in claim 12, wherein the power transmission device includes an input port and an output port, the input port connects with a power source, and the output port connects with the corresponding connection apparatus.
